(19) United States
(12) Patent Application Publication
(10) Pub. No.: US 2023/0020115 A1
(43) Pub. Date: Jan. 19, 2023

(54) ELECTROCHEMICAL APPARATUS AND ELECTRONIC APPARATUS

(71) Applicant: NINGDE AMPEREX TECHNOLOGY LIMITED, Ningde (CN)

(72) Inventor: Junhui HOU, Ningde (CN)

(21) Appl. No.: 17/953,223

(22) Filed: Sep. 26, 2022

Related U.S. Application Data
(63) Continuation of application No. PCT/CN2020/081493, filed on Mar. 26, 2020.

(51) Int. Cl. H01M 50/536; H01M 50/533; H01M 4/70; H01M 50/172

(52) U.S. Cl. CPC H01M 50/536; H01M 50/533; H01M 4/70; H01M 50/172

(57) ABSTRACT

An electrochemical apparatus includes a first electrode plate and a first tab. The first electrode plate includes a current collector and an active material layer disposed on the current collector. The current collector includes a first surface, a first side and a second side opposite to the first side; the first surface is provided with a first blank region and the first tab is electrically connected to the first blank region and protrudes from the first side. A first tab adhesive is provided on the first tab, where the first tab adhesive includes a first adhesive layer, and the first adhesive layer includes a third side facing toward the second side. A minimum distance D₁ mm between the third side and the second side and a distance W mm between the first side and the second side satisfy D₁<W.

### CROSS-REFERENCE TO RELATED APPLICATION

The present application is a continuation-in-part application of PCT Application No. PCT/CN2020/081493, filed on Mar. 26, 2020, the content of which is incorporated by reference in its entirety.

### TECHNICAL FIELD

This application relates to the field of energy storage technologies, and in particular, to an electrochemical apparatus and an electronic apparatus containing the electrochemical apparatus.

### BACKGROUND

Electrochemical apparatuses (such as batteries) are widely used in electronic products such as electronic mobile devices, electric tools, and electric vehicles, and increasingly higher requirements are imposed on safety performance of the electrochemical apparatuses. During use of electronic products, mechanical abuse, such as drop, collision and vibration, often occurs, which leads to an increasingly higher requirement on anti-drop performance of the electrochemical apparatuses.

A cathode tab of electrochemical apparatus is generally made of aluminum foil while an anode tab thereof is generally made of copper foil or nickel foil, and tabs can be used as connecting parts between an electrochemical apparatus and an external charging or discharging device. When an electronic product is dropped, if anti-bending strength of the tab is not enough to withstand an impact on the electrochemical apparatus, the tab may break. As a result, electric energy stored in the electrochemical apparatus cannot be delivered to the outside, and external electric energy cannot be delivered to the electrochemical apparatus, thereby leading to failure of the electrochemical apparatus, and reduced safety, reliability, and service life of the electrochemical apparatus.

### SUMMARY

In view of the disadvantages of the prior art, it is necessary to provide an electrochemical apparatus that helps to alleviate a problem of tab breaking.

In addition, it is further necessary to provide an electronic apparatus having such electrochemical apparatus.

This application provides an electrochemical apparatus, including a first electrode plate and a first tab, where the first electrode plate includes a current collector and an active material layer disposed on the current collector. The current collector includes a first surface, a first side and a second side opposite to the first side; the first surface is provided with a first blank region and the first tab is electrically connected to the first blank region and protrudes from the first side. A first tab adhesive is provided on the first tab, where the first tab adhesive includes a first adhesive layer, and the first adhesive layer includes a third side facing toward the second side. A minimum distance D₁ mm between the third side and the second side and a distance W mm between the first side and the second side satisfy D₁<W.

The third side of the first adhesive layer of this application is lower than the first side of the first electrode plate, enabling the third side of the first adhesive layer to be clamped in the interior of an electrode assembly. In case of mechanical abuse of the electrochemical apparatus, with the first adhesive layer being clamped, the first tab can be prevented from being broken due to skewing, thus avoiding failure of the electrochemical apparatus and improving safety, reliability, and service life of the electrochemical apparatus.

In some embodiments of this application, the first adhesive layer covers part of the first blank region. As a result, when there is a gap between the third side of the first adhesive layer and the first blank region, stress concentration at a junction between the first tab and the third side of the first adhesive layer can be avoided, further preventing the first tab from being broken due to stress concentration.

In some embodiments of this application, the first blank region includes a fourth side away from the second side, and a distance D₂ mm between the fourth side and the second side is less than D₁. The third side of the first adhesive layer may be clamped by other regions on the first side that have no notch, which can also prevent the first tab from being broken due to skewing.

In some embodiments of this application, D₁<W−0.2. In this way, the first adhesive layer can extend into the electrode assembly by a sufficient length, which helps to prevent the first adhesive layer from being separated from the first blank region in case of mechanical abuse of the electrochemical apparatus, thus further improving the safety, reliability, and service life of the electrochemical apparatus.

In some embodiments of this application, a direction from the second side to the first side is a first direction; and in the first direction, the first adhesive layer includes a first portion and a second portion connected to the first portion, where the third side is located in the first portion and a length of the first portion is less than that of the second portion. Due to different dimensions of the first portion and the second portion, the first portion of the first adhesive layer can be made of less materials, reducing production cost.

In some embodiments of this application, a joint between the first portion and the second portion or an edge of the first portion is provided with a concave-convex structure.

In some embodiments of this application, the current collector further includes a second surface opposite the first surface, where the second surface includes a second blank region, with a projection of the first tab on the second surface being located inside the second blank region. The first tab adhesive includes a second adhesive layer which is connected to the first adhesive layer, where the first tab is located between the first adhesive layer and the second adhesive layer, and the second adhesive layer includes a fifth side facing toward the second side. A minimum distance D₃ mm between the fifth side and the second side is less than W. That is, the fifth side of the second adhesive layer can be clamped in the interior of the electrode assembly. In case of mechanical abuse of the electrochemical apparatus, with the second adhesive layer being clamped, the first tab can be further prevented from being broken due to skewing, thereby avoiding the failure of the electrochemical apparatus and improving the safety, reliability, and service life of the electrochemical apparatus.

In some embodiments of this application, the first blank region is located in the middle of the current collector. In this way, internal resistance of the electrochemical apparatus can be reduced, improving high-rate charge/discharge performance of the electrochemical apparatus.

In some embodiments of this application, the electrochemical apparatus further includes a second tab, the first surface is provided with a third blank region, and the second tab is electrically connected to the third blank region and protrudes from the first side. A second tab adhesive is provided on the second tab, where the second tab adhesive includes a third adhesive layer, and the third adhesive layer includes a sixth side facing toward the second side. A minimum distance D₄ mm between the sixth side and the second side is less than W. The second tab is provided on the first electrode plate of the electrochemical apparatus, which can further improve high-rate charge/discharge performance of the electrochemical apparatus. In addition, the sixth side of the third adhesive layer can be clamped in the interior of the electrode assembly. In case of mechanical abuse of the electrochemical apparatus, with the third adhesive layer being clamped, the second tab can be prevented from being broken, improving the safety, reliability, and service life of the electrochemical apparatus.

This application further provides an electronic apparatus including the electrochemical apparatus.

### BRIEF DESCRIPTION OF DRAWINGS

FIG. 1 is a schematic structural diagram of an electrochemical apparatus according to an embodiment of this application.

FIG. 2 is a schematic cross-sectional diagram of an electrode assembly of the electrochemical apparatus shown in FIG. 1.

FIG. 3A is a schematic front-view structural diagram of an embodiment of an unwound first electrode plate of the electrode assembly shown in FIG. 2.

FIG. 3B is a schematic rear-view diagram of the first electrode plate shown in FIG. 3A.

FIG. 4 is a schematic side-view structural diagram of a first tab on the first electrode plate shown in FIG. 3A and FIG. 3B.

FIG. 5 is a schematic front-view structural diagram of another embodiment of an unwound first electrode plate of the electrode assembly shown in FIG. 2.

FIG. 6 is a schematic rear-view structural diagram of still another embodiment of an unwound first electrode plate of the electrode assembly shown in FIG. 2.

FIG. 7 is a schematic side-view structural diagram of a first tab on the first electrode plate shown in FIG. 6.

FIG. 8 is a schematic front-view structural diagram of yet another embodiment of an unwound first electrode plate of the electrode assembly shown in FIG. 2.

FIG. 9 is a schematic rear-view structural diagram of the first electrode plate shown in FIG. 8.

FIG. 10 is a schematic front-view structural diagram of an embodiment of a first tab on the first electrode plate shown in FIG. 8.

FIG. 11 is a schematic front-view structural diagram of another embodiment of a first tab on the first electrode plate shown in FIG. 8.

FIG. 12 is a schematic front-view structural diagram of yet another embodiment of an unwound first electrode plate of the electrode assembly shown in FIG. 2.

FIG. 13 is a schematic front-view structural diagram of yet another embodiment of an unwound first electrode plate of the electrode assembly shown in FIG. 2.

FIG. 14 is a schematic structural diagram of an electronic apparatus according to an embodiment of this application.

### REFERENCE SIGNS OF MAIN COMPONENTS

Electronic apparatus 1
First electrode plate 10
Current collector 11
Active material layer 12
First tab 20
First tab adhesive 30
First adhesive layer 31
Second adhesive layer 32
Second electrode plate 40
Second tab adhesive 60
Third adhesive layer 61
Fourth adhesive layer 62
Tab 70
Electrochemical apparatus 100
Electrode assembly 101
First surface 111
First blank region 112
First side 113
Second side 114
Second surface 115
Second blank region 116
Fourth side 117
Third blank region 118
Third side 310
First portion 311
Second portion 312
Fifth side 320
Sixth side 610
Distance D₁, D₂, D₃, and W

This application will be further described with reference to the accompanying drawings in the following specific embodiments.

### DETAILED DESCRIPTION

The technical solutions in the embodiments of this application are described clearly and completely below with reference to the accompanying drawings in the embodiments of this application. Apparently, the described embodiments are only some rather than all of the embodiments of this application. All other examples obtained by a person of ordinary skill in the art based on the examples of this application shall fall within the protection scope of this application.

Unless otherwise defined, all technical and scientific terms used herein shall have the same meanings as commonly understood by those skilled in the art to which this application belongs. The terms used herein in the specification of this application are merely intended to describe specific embodiments but not intended to limit this application.

The following describes in detail some embodiments of this application with reference to the accompanying drawings. In absence of conflicts, the following embodiments and features in the embodiments may be combined.

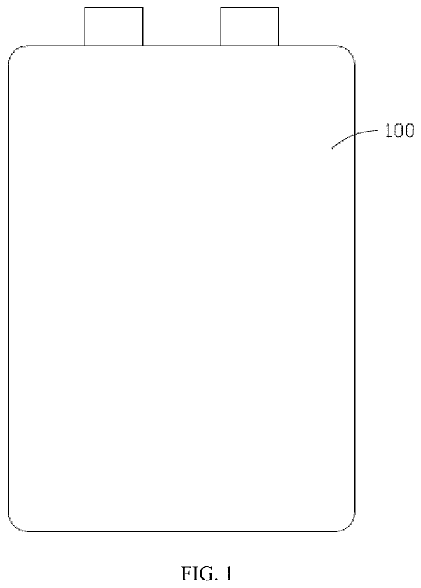

Referring to FIG. 1 to FIG. 3A, an embodiment of this application provides an electrochemical apparatus 100, including a first electrode plate 10 and a first tab 20. The first electrode plate 10 includes a current collector 11 and an active material layer 12 provided on the current collector 11. The current collector 11 includes a first surface 111 provided with a first blank region 112. The current collector 11 includes a first side 113 and a second side 114 opposite to the first side 113, and the first tab 20 is electrically connected to the first blank region 112 and protrudes from the first side 113.

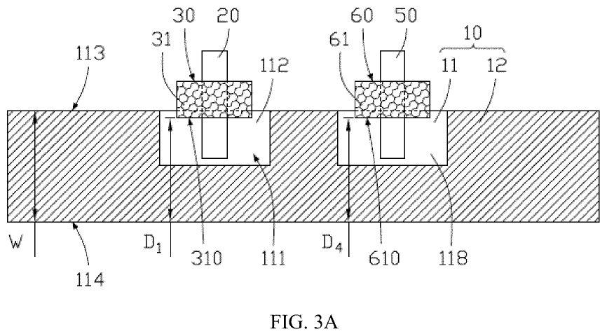

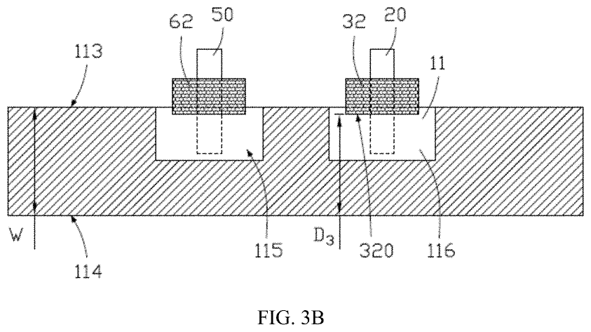

As shown in FIG. 3A, a first tab adhesive 30 is provided on the first tab 20, where the first tab adhesive 30 includes a first adhesive layer 31, and the first adhesive layer 31 includes a third side 310 facing toward the second side 114. A minimum distance D₁ mm between the third side 310 and the second side 114 and a distance W mm between the first side 113 and the second side 114 satisfy D₁<W.

The third side 310 may be straight, curvilinear, or of any other shapes. When the third side 310 is straight, the third side 310 may be parallel to the first side 113 or may be not parallel to the first side 113. The minimum distance D₁ refers to a minimum distance from each point on the third side 310 to the second side 114.

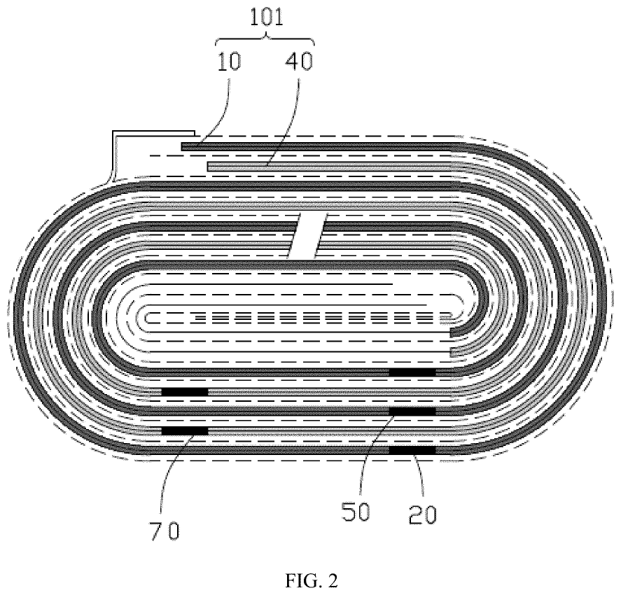

It may be understood that, specifically, as shown in FIG. 2, the electrochemical apparatus 100 further includes a second electrode plate 40 and a separator (not shown in the figure) which is located between the first electrode plate 10 and the second electrode plate 40. The first electrode plate 10, the separator, and the second electrode plate 40 may be made into an electrode assembly 101 through lamination or winding. The electrode assembly 101 shown in FIG. 2 is of a wound structure, but is not limited thereto in this application, and the electrode assembly 101 may alternatively be of a laminated structure.

The electrochemical apparatus 100 includes a housing accommodating the first electrode plate 10. In some embodiments, the electrochemical apparatus 100 may be a pouch-type cell, and the housing is flexible. In some embodiments, the housing includes a protective layer, a metal layer and a heat sealing layer, and the protective layer and the metal layer and the heat sealing layer may be respectively bonded and compounded by an adhesive layer. In some embodiments, the protective layer includes at least one of PET (polyethyleneglycol terephthalate), PEN (poly (2, 6-ethylene naphthalate)), or polycaprolactam. In some embodiments, the metal layer includes at least one of aluminum, steel, or titanium. In some embodiments, the heat sealing layer includes polyolefin. In some embodiments, the heat sealing layer includes at least one of polyethylene or polypropylene. The first tab adhesive 30 is fixedly connected to the heat sealing layer to seal the housing. In some embodiments, the first tab adhesive 30 includes at least one of polyethylene, polypropylene, polyimide, or polyethyleneglycol terephthalate. The first tab 20 extends out of the housing through the first tab adhesive 30. The first tab adhesive 30 is located on the two opposite surface of the first tab 20.

In this application, the minimum distance D₁ between the third side 310 and the second side 114 is less than the distance W between the first side 113 and the second side 114, so that the third side 310 of the first adhesive layer 31 is lower than the first side 113 of the first electrode plate 10. Therefore, the third side 310 of the first adhesive layer 31 can be clamped in the interior of the electrode assembly 101. In case of mechanical abuse of the electrochemical apparatus 100, with the first adhesive layer 31 being clamped, the first tab 20 can be prevented from being broken due to skewing, thus avoiding the failure of the electrochemical apparatus 100 and improving the safety, reliability, and service life of the electrochemical apparatus 100.

In some embodiments of this application, as shown in FIG. 3A, a difference between the distance W from the first side 113 to the second side 114 and the minimum distance D₁ from the third side 310 to the second side 114 is greater than 0.2 mm, that is, D₁<W−0.2. In this way, the first adhesive layer 31 can extend into the electrode assembly 101 by a sufficient length, which helps to prevent the first adhesive layer 31 from being separated from the first blank region 112 in case of mechanical abuse of the electrochemical apparatus 100, thereby preventing the first tab 20 from being broken and further improving the safety, reliability, and service life of the electrochemical apparatus 100.

The following will describe this application in detail with reference to specific examples.

### Example 1

As shown in FIG. 3A, in this example, the first adhesive layer 31 covers part of the first blank region 112, so that D₁ is less than W. The first adhesive layer 31 covers part of the first blank region 112, enabling to avoid stress concentration that is prone to occur at a junction between a first tab 20 and the third side 310 of the first adhesive layer 31 when there is a gap between a third side 310 of the first adhesive layer 31 and the first blank region 112, thereby preventing the first tab 20 from being broken due to stress concentration.

As shown in FIG. 3B, a current collector 11 further includes a second surface 115 opposite to a first surface 111, where the second surface 115 includes a second blank region 116, with a projection of the first tab 20 on the second surface 115 being located inside a second blank region 116. A first tab adhesive 30 includes a second adhesive layer 32 which is connected to the first adhesive layer 31, and the first tab 20 is located between the first adhesive layer 31 and a second adhesive layer 32. The second adhesive layer 32 includes a fifth side 320 facing toward a second side 114. A minimum distance D₃ mm between the fifth side 320 and the second side 114 is less than W.

For example, in this example, the first adhesive layer 32 covers part of the second blank region 116. The second adhesive layer 32 covers part of the second blank region 116, enabling to avoid stress concentration that is prone to occur at a junction between the first tab 20 and the fifth side 320 of the second adhesive layer 32 when there is a gap between the fifth side 320 of the second adhesive layer 32 and the second blank region 116, thereby preventing the first tab 20 from being broken due to stress concentration.

The fifth side 320 may be straight, curvilinear or of any other shapes. When the fifth side 320 is straight, the fifth side 320 may be parallel to the first side 113 or may be not parallel to the first side 113. The minimum distance D₁ refers to a minimum distance from each point on the fifth side 320 to the second side 114.

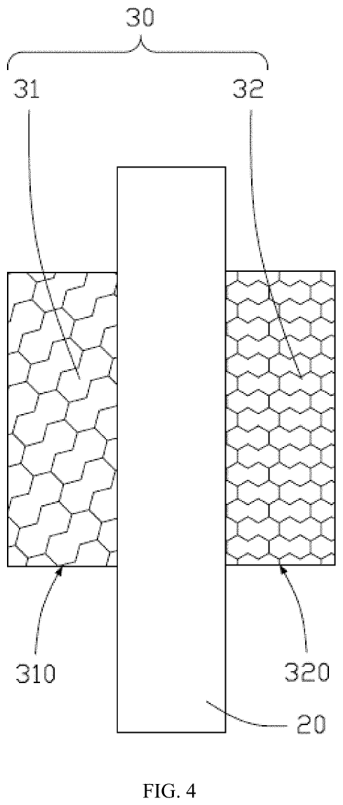

Referring to FIG. 3A, FIG. 3B and FIG. 4 together, the fifth side 320 may be flush with the third side 310. Specifically, when a difference between the distance W from the first side 113 to the second side 114 and the minimum distance D₁ from the third side 310 to the second side 114 is greater than 0.2 mm (that is, D₁<W−0.2), a difference between the distance W from the first side 113 to the second side 114 and the minimum distance D₃ from the fifth side 320 to the second side 114 is also greater than 0.2 mm (that is, D₃<W−0.2).

As shown in FIG. 3A, in this example, the first blank region 112 is located in the middle of the current collector 11. The first blank region 112 is a region on the current collector 11 with no active material layer 12 thereon, which may be formed by applying the active material layer 12 on the current collector 11 and then removing the active material layer at a corresponding location of the first blank region 112 to expose the current collector, or by applying polystyrene foam to a corresponding location of the first blank region 112, applying the active material layer 12, and then heating to remove the polystyrene foam and an active material layer attached to the polystyrene foam, or by other methods, which are not limited herein.

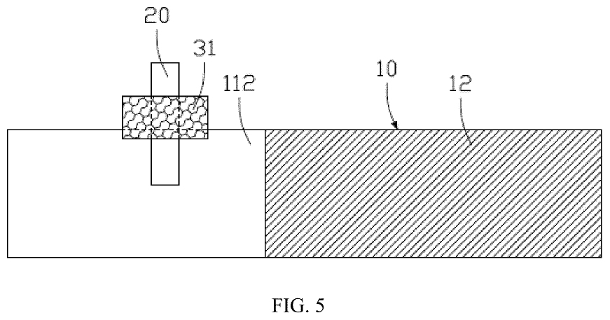

In this way, the first tab 20 can be located in the middle of the current collector 11, thus shortening a current transmission distance, reducing internal resistance of an electrochemical apparatus 100, and improving high-rate charge/discharge performance of the electrochemical apparatus 100. Certainly, as shown in FIG. 5, the first blank region 112 may also be located in a head or tail of the current collector 11.

As shown in FIG. 3A and FIG. 3B, in this example, the first adhesive layer 31 matches the second adhesive layer 32 in shape, both of which may be roughly rectangular.

### Example 2

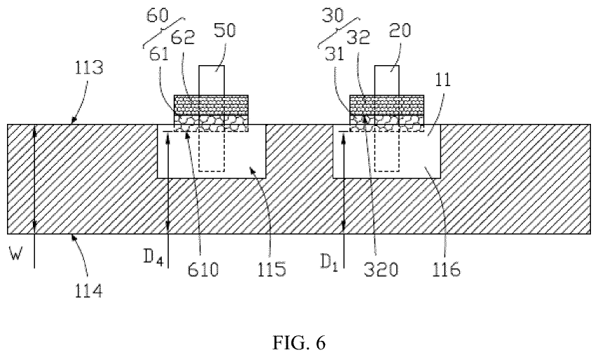

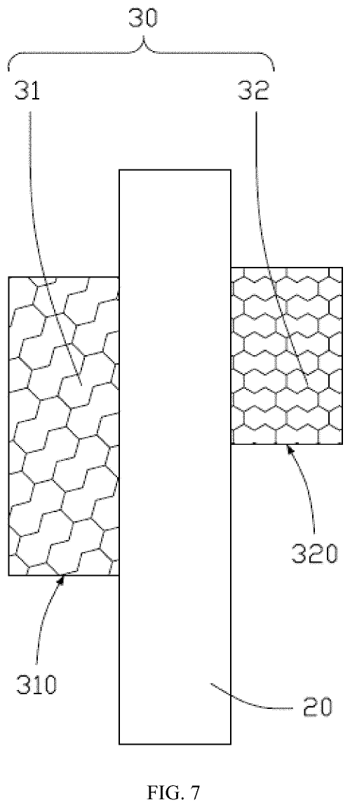

Referring to FIG. 6, a difference from Example 1 is that, under a condition that a first adhesive layer 31 covers part of a first blank region 112, a second adhesive layer 32 of this example may alternatively not cover a second blank region 116. That is, there may alternatively be a gap between a fifth side 320 of a second adhesive layer 32 and the second blank region 116. In this case, the second adhesive layer 32 is smaller than the first adhesive layer 31 in width.

A direction from a second side 114 to a first side 113 is a first direction, and the foregoing width is defined as a width of the second adhesive layer 32 or the first adhesive layer 31 in the first direction.

In this case, in spite of the gap between the fifth side 320 of the second adhesive layer 32 and the second blank region 116 leading to stress concentration that is prone to occur at a junction between the fifth side 320 and a first tab 20, at least part of stresses generated at the junction between the fifth side 320 and the first tab 20 can be transferred to a side of the first adhesive layer 31. With the first adhesive layer 31 covering part of the first blank region 112, part of the stress that has been transferred to the first adhesive layer 31 can be relieved, thereby also preventing the first tab 20 from being broken due to the stress concentration.

### Example 3

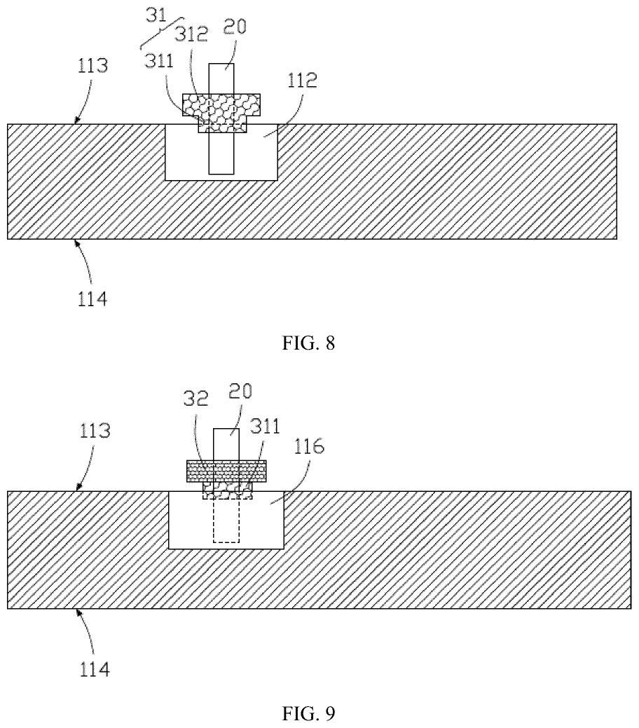

A difference from Example 1 or Example 2 is that, a first adhesive layer 31 of this example is not limited to a rectangular shape. As shown in FIG. 8, in this example, in a first direction, the first adhesive layer 31 includes a first portion 311 and a second portion 312 connected to the first portion 311, where a third side 310 is located in the first portion 311, and a length of the first portion 311 is less than that of the second portion 312.

In other words, the first portion 311 covers part of a first blank region 112.

The first portion 311 and the second portion 312 may be integrally formed to simplify the process. Certainly, the first portion 311 and the second portion 312 may alternatively not be integrally formed.

The foregoing length is defined as a dimension of the first portion 311 or the second portion 312 in a second direction that is perpendicular to the first direction. A length of the first portion 311 is less than that of the second portion 312. To be specific, the first adhesive layer 31 is roughly T-shaped. With the length of the first portion 311 less than that of the second portion 312, the first portion 311 of the first adhesive layer 31 can be made of less materials, reducing production cost.

Similarly, a second adhesive layer 32 may have a same shape as the first adhesive layer 31. To be specific, the second adhesive layer 32 may also be roughly T-shaped. With the first portion 311 of the first adhesive layer 31 covering part of the first blank region 112, similar to Example 1, the second adhesive layer 32 may cover part of a second blank region 116.

### Example 4

A difference from Example 3 is that, with a first adhesive layer 31 of T-shaped, a second adhesive layer 32 of this example does not cover a second blank region 116. In other words, as shown in FIG. 9, there is a gap between the second adhesive layer 32 and the second blank region 116.

Due to different dimensions of a first portion 311 and a second portion 312 of the first adhesive layer 31, on the first adhesive layer 31, stresses are more prone to occur at a joint between a first portion 311 and a second portion 312, so that the stresses on the second adhesive layer 32 can be transferred to the first adhesive layer 31 more quickly, thereby preventing a first tab 20 from being broken due to stress concentration.

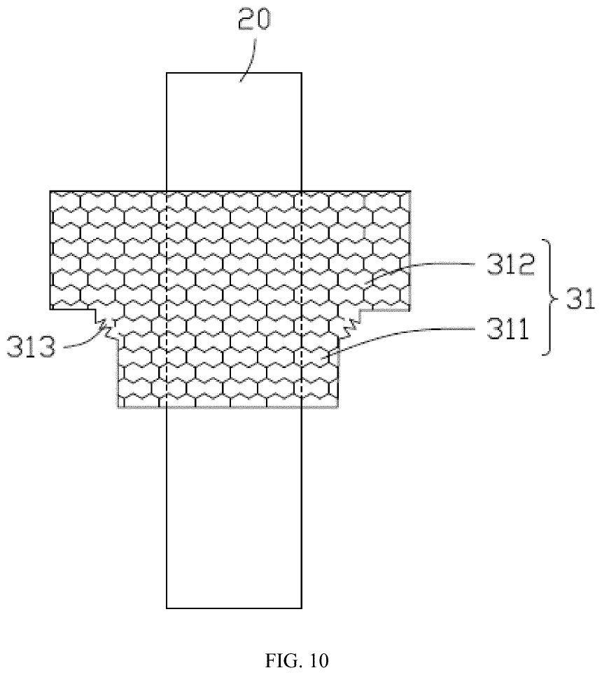

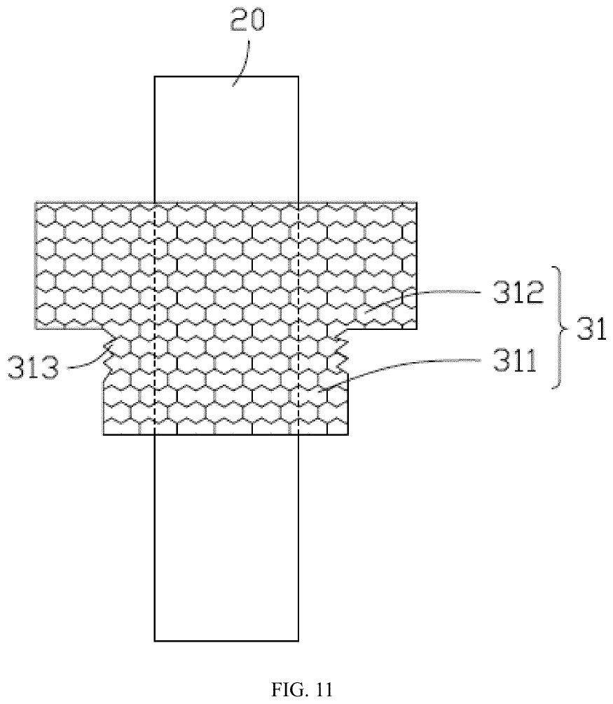

As shown in FIG. 10 and FIG. 11, in this example, the joint between the first portion 311 and the second portion 312 or an edge of the first portion 311 may be provided with a concave-convex structure 313. The concave-convex structure 313 may be a zigzag structure. The concave-convex structure 313 is used to produce a sharp change in shape on the first adhesive layer 31, so that the stresses on the second adhesive layer 32 can be transferred to the first adhesive layer 31 more quickly.

Certainly, increasing a difference in length between the first portion 311 and the second portion 312 may also help to transfer the stresses on the second adhesive layer 32 to the first adhesive layer 31 more quickly.

### Example 5

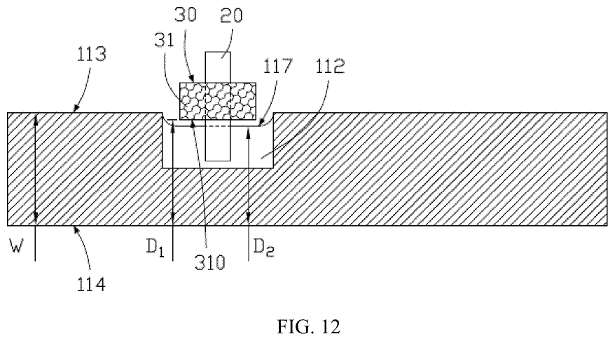

A difference from Example 1 is that, in order to make D₁ less than W, a first tab 20 does not need to cover a first blank region 112. As shown in FIG. 12, in this example, the first blank region 112 includes a fourth side 117 that is away from a second side 114, a distance D₂ mm between the fourth side 117 and the second side 114 being less than D₁.

As shown in FIG. 12, specifically, the first blank region 112 is provided with a notch, forming the fourth side 117 in the first blank region 112. In this case, in spite of a gap between a third side 310 of a first adhesive layer 31 and the first blank region 112, for a wound electrode assembly 101, winding of a first electrode plate 10 makes the third side 310 of the first adhesive layer 31 lower than a first side 113 of a first electrode plate 10, allowing the third side 310 of the first adhesive layer 31 to be clamped by other regions on the first side 113 that have no notch, which can also prevent the first tab 20 from being broken due to skewing.

As shown in FIG. 12, the first adhesive layer 31 may be rectangular, similar to Example 1. However, as show in FIG. 13, the first adhesive layer 31 may also be T-shaped as shown in Example 2.

Further, a second adhesive layer 32 may match the first adhesive layer 31 in shape and may also be smaller than the first adhesive layer 31 in width.

In Examples 1 to 5, the first tab 20 may be welded to the first blank region 112. In other examples, the first tab 20 may also be integrally formed in the first blank region 112. For example, the first tab 20 may be directly formed by cutting a current collector.

As shown in FIG. 2 and FIG. 3A, in this embodiment, the electrochemical apparatus 100 further includes a second tab 50. The first surface 111 is further provided with a third blank region 118, where the second tab 50 is electrically connected to the third blank region 118 and protrudes from a first side 113. A second tab adhesive 60 is provided on the second tab 50. The second tab adhesive 60 includes a third adhesive layer 61 which includes a sixth side 610 facing toward a second side 114. A minimum distance D₄ mm between the sixth side 610 and the second side 114 is less than W.

The sixth side 610 may be straight, curvilinear or of any other shapes. When the sixth side 610 is straight, the sixth side 610 may be parallel to the first side 113 or may be not parallel to the first side 113. The minimum distance D₁ refers to a minimum distance from each point on the sixth side 610 to the second side 114.

If a first electrode plate 10 is further provided with the second tab 50, with an increased number of tabs on the first electrode plate 10, the electrochemical apparatus 100 can have better high-rate charge/discharge performance. In this application, the third adhesive layer 61 has a similar structure as the first adhesive layer 31. In other words, the minimum distance D₄ between the sixth side 610 and the second side 114 is less than the distance W between the first side 113 and the second side 114, so that the sixth side 610 of the third adhesive layer 61 is lower than the first side 113 of the first electrode plate 10, which can prevent the second tab 50 from being broken due to skewing and further improve the safety, reliability, and service life of the electrochemical apparatus 100.

As shown in FIG. 3B, a second tab adhesive 60 may further includes a fourth adhesive layer 62 which is connected to a third adhesive layer 61. The third adhesive layer 61 and the fourth adhesive layer 62 of the second tab adhesive 60 may adopt, respectively, a same structure as a first adhesive layer 31 and a second adhesive layer 32 of a first tab adhesive 30 in Examples 1 to 5, and details are not described herein again.

To further improve high-rate charge/discharge performance of the electrochemical apparatus 100, the first electrode plate 10 may be further provided with a third tab, a fourth tab (not shown in the figure), and the like which are also provided with a tab adhesive respectively. To prevent the third tab and the fourth tab from being broken, the tab adhesive on the third tab and the fourth tab can have a similar structure as a first tab adhesive 30 in Examples 1 to 5. Details are not described herein again.

Similarly, as shown in FIG. 2, at least one tab 70 is disposed on a second electrode plate 40. Specifically, the second electrode plate 40 includes a second current collector and a second active material layer disposed on the second current collector. The second current collector includes a first surface which is also provided with a first blank region. The second current collector also includes a first side and a second side opposite to the first side. The tab 70 on the second electrode plate 40 is electrically connected to the first blank region of the second current collector and protrudes from the first side. The tab 70 on the second electrode plate 40 is also provided with a tab adhesive (not shown in the figure). To prevent the tab 70 on the second electrode plate 40 from being broken, the tab adhesive on the second electrode plate 40 may have a similar structure as a first tab adhesive 30 in Examples 1 to 5. Details are not described herein again.

The electrochemical apparatus 100 in this application includes all apparatuses capable of electrochemical reactions. Specifically, the electrochemical apparatus 100 includes all kinds of primary batteries, secondary batteries, fuel batteries, solar batteries, or capacitors (for example, super capacitors). Optionally, the electrochemical apparatus 100 may be a secondary lithium battery, including a secondary lithium metal battery, a secondary lithium-ion battery, a secondary lithium polymer battery, or a secondary lithium-ion polymer battery.

Mini drop tests were separately performed on electrochemical apparatuses of Examples 1 to 5. Specifically, each electrochemical apparatus was placed in an analog clamp, fixed with a double-sided adhesive, and covered with a cover plate. Each electrochemical apparatus was dropped from a height of 10 cm to a marble floor repeatedly in turn, and was subjected to 5,000 drops on its head, 2,500 on its left side, and 2,500 on its right side. It was confirmed that none of tabs were broken after repeated drops of each electrochemical apparatus of Examples 1 to 5.

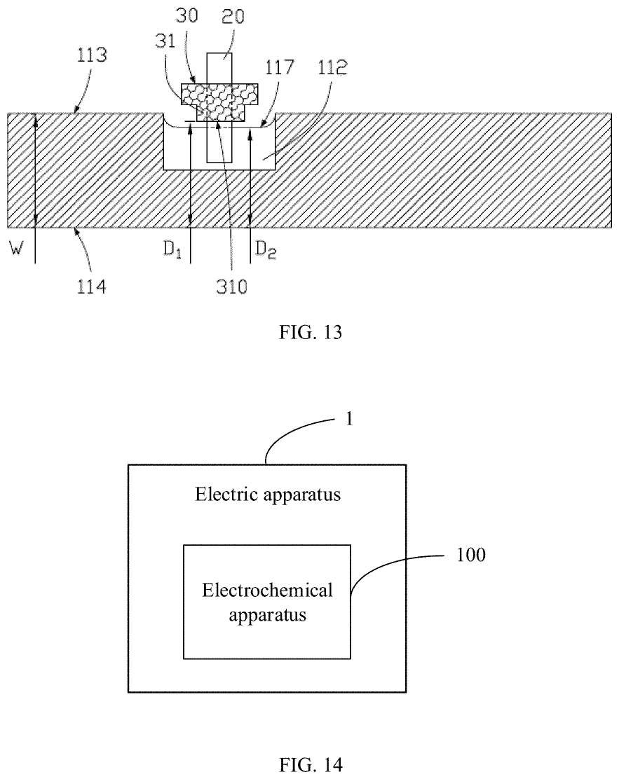

Referring to FIG. 14, an embodiment of this application further provides an electrical apparatus 1 which includes the electrochemical apparatus 100. The electric apparatus 1 may be a consumer electronic product (such as a mobile communications apparatus, a tablet computer, a laptop computer, a wearable device, and the like), an electric tool, an unmanned aerial vehicle, an energy storage apparatus, a power apparatus, or the like. In an embodiment, the electric apparatus 1 is a mobile communications apparatus.

In conclusion, it should be noted that the foregoing embodiments are merely intended to describe the technical solutions of this application, but not intended to constitute any limitation. Although this application is described in detail with reference to preferred embodiments, persons of ordinary skill in the art should understand that modifications or equivalent replacements can be made to the technical solutions of this application, without departing from the spirit and scope of the technical solutions of this application.

What is claimed is:

1. An electrochemical apparatus, comprising: a first electrode plate and a first tab, wherein the first electrode plate comprises a current collector and an active material layer disposed on the current collector; wherein
the current collector comprises a first surface, a first side and a second side opposite to the first side; the first surface is provided with a first blank region and the first tab is electrically connected to the first blank region and protrudes from the first side; and
a first tab adhesive is provided on the first tab, wherein the first tab adhesive comprises a first adhesive layer, and the first adhesive layer comprises a third side facing toward the second side;
wherein a minimum distance D₁ mm between the third side and the second side and a distance W mm between the first side and the second side satisfy D₁<W.

2. The electrochemical apparatus according to claim 1, wherein the first adhesive layer covers part of the first blank region.

3. The electrochemical apparatus according to claim 1, wherein the first blank region comprises a fourth side, the fourth side is away from the second side, and a distance D₂ mm between the fourth side and the second side is less than D₁.

4. The electrochemical apparatus according to claim 1, wherein D₁<W−0.2.

5. The electrochemical apparatus according to claim 1, wherein a direction from the second side to the first side is a first direction; and in the first direction, the first adhesive layer comprises a first portion and a second portion connected to the first portion; wherein the third side is located in the first portion and a length of the first portion is less than that of the second portion.

6. The electrochemical apparatus according to claim 5, wherein a joint between the first portion and the second portion or an edge of the first portion is provided with a concave-convex structure.

7. The electrochemical apparatus according to claim 1, wherein the current collector further comprises a second surface opposite to the first surface, and the second surface comprises a second blank region, with a projection of the first tab on the second surface being located inside the second blank region; and
the first tab adhesive comprises a second adhesive layer connected to the first adhesive layer, the first tab is located between the first adhesive layer and the second adhesive layer, and the second adhesive layer comprises a fifth side facing toward the second side;
wherein a minimum distance D₃ mm between the fifth side and the second side is less than W.

8. The electrochemical apparatus according to claim 1, wherein the first blank region is located in the middle of the current collector.

9. The electrochemical apparatus according to claim 1, wherein the electrochemical apparatus further comprises a second tab, the first surface is further provided with a third blank region, and the second tab is electrically connected to the third blank region and protrudes from the first side; and
a second tab adhesive is provided on the second tab, wherein the second tab adhesive comprises a third adhesive layer, and the third adhesive layer comprises a sixth side facing toward the second side;
wherein a minimum distance D₄ mm between the sixth side and the second side is less than W.

10. The electrochemical apparatus according to claim 1, wherein the electrochemical apparatus further comprises a housing, the first tab adhesive is connected to the housing, the first tab extends out of the housing through the first tab adhesive, and the first tab adhesive comprises at least one of polyethylene, polypropylene, polyimide, or polyethyleneglycol terephthalate.

11. An electronic apparatus, comprising an electrochemical apparatus, wherein the electrochemical apparatus comprises a first electrode plate and a first tab, wherein the first electrode plate comprises a current collector and an active material layer disposed on the current collector, wherein
the current collector comprises a first surface, a first side and a second side opposite to the first side; the first surface is provided with a first blank region and the first tab is electrically connected to the first blank region and protrudes from the first side; and
a first tab adhesive is provided on the first tab, wherein the first tab adhesive comprises a first adhesive layer, and the first adhesive layer comprises a third side facing toward the second side;
wherein a minimum distance D₁ mm between the third side and the second side and a distance W mm between the first side and the second side satisfy D₁<W.

12. The electronic apparatus according to claim 11, wherein the first adhesive layer covers part of the first blank region.

13. The electronic apparatus according to claim 11, wherein the first blank region comprises a fourth side, the fourth side is away from the second side, and a distance D₂ mm between the fourth side and the second side is less than D₁.

14. The electronic apparatus according to claim 11, wherein D₁<W−0.2.

15. The electronic apparatus according to claim 11, wherein a direction from the second side to the first side is a first direction; and in the first direction, the first adhesive layer comprises a first portion and a second portion connected to the first portion; wherein the third side is located in the first portion and a length of the first portion is less than that of the second portion.

16. The electronic apparatus according to claim 11, wherein a joint between the first portion and the second portion or an edge of the first portion is provided with a concave-convex structure.

17. The electronic apparatus according to claim 11, wherein the current collector further comprises a second surface opposite to the first surface, and the second surface comprises a second blank region, with a projection of the first tab on the second surface being located inside the second blank region; and
the first tab adhesive comprises a second adhesive layer connected to the first adhesive layer, the first tab is located between the first adhesive layer and the second adhesive layer, and the second adhesive layer comprises a fifth side facing toward the second side;
wherein a minimum distance D₃ mm between the fifth side and the second side is less than W.

18. The electronic apparatus according to claim 11, wherein the first blank region is located in the middle of the current collector.

19. The electronic apparatus according to claim 11, wherein the electrochemical apparatus further comprises a second tab, the first surface is further provided with a third blank region, and the second tab is electrically connected to the third blank region and protrudes from the first side; and
a second tab adhesive is provided on the second tab, wherein the second tab adhesive comprises a third adhesive layer, and the third adhesive layer comprises a sixth side facing toward the second side;
wherein a minimum distance D₄ mm between the sixth side and the second side is less than W.

20. The electronic apparatus according to claim 11, wherein the electrochemical apparatus further comprises a housing, the first tab adhesive is connected to the housing, the first tab extends out of the housing through the first tab adhesive, and the first tab adhesive comprises at least one of polyethylene, polypropylene, polyimide, or polyethyleneglycol terephthalate.
